(19) United States
(12) Patent Application Publication
(10) Pub. No.: US 2010/0153942 A1
(43) Pub. Date: Jun. 17, 2010

(54) METHOD AND A SYSTEM FOR DELIVERING LATEST HOTFIXES WITH A SUPPORT PACKAGE STACK

(76) Inventors: Lazar Borissov, Sofia (BG); Dimitar Grancharov, Sofia (BG); Stoyan Rachev, Sofia (BG); Galya Zhivkova, Sofia (BG)

Correspondence Address: SAP AG, 3410 HILLVIEW AVENUE, PALO ALTO, CA, 94304, US

(21) Appl. No.: 12/333,348

(22) Filed: Dec. 12, 2008

(51) Int. Cl. G06F 9/445

(52) U.S. Cl. 717/169

(57) ABSTRACT

A method and a system are described that involve delivering latest hotfixes with a support package stack. In one embodiment, the method includes receiving a selection of a stack of update components, the stack to be applied on a product and receiving correction data for an update component of the stack, the correction data being available on a software provider system. The method also includes detecting the correction data for the update component. Further, the method includes applying the correction data on the update component in the stack.

In one embodiment, the system includes a stack of update components, the stack to be applied on a product and correction data for an update component from the stack of update components, the correction data being available on a software provider system. The system also includes an upgrade tool to detect the correction data for the update component, the correction data is received from the software provider system, and to apply the correction data to the update component in the stack.

### FIELD OF INVENTION

Embodiments of the invention relate generally to the software arts, and, more specifically, to a method and a system for delivering latest hotfixes with a support package stack.

### BACKGROUND

Often, in computing and consumer electronics, upgrade of a product with a newer or better version of the same product is performed. Generally, the term “upgrade” refers to the replacement of hardware, software, or firmware with a newer version to bring the system up-to-date or to improve its characteristics. In hardware, common upgrades could be in the form of installing additional memory (for example, random-access memory (RAM)), adding larger hard disks, replacing microprocessor cards, and so on. In software, common upgrades could refer to changing the version of the operating system, the anti-virus program, the application server, and various other programs, tools, and services. The common firmware upgrades may include updating the iPod control menus, flash memory cards, and so on. The software upgrades are usually downloaded from the Internet. Most software companies provide own Web sites, where detailed information for any available product upgrades can be obtained.

Often times, the download upgrade is a patch of a new version and does not include the new version in its entirety. The patch is a small piece of software that aims to fix problems such as fixing bugs in the source code, replacing graphics, improving usability or performance, and so on. Large pieces of software that significantly change a program can be referred to as “service packages” or “support packages”. A service package, or service pack (SP), is a collection of updates, fixes, or enhancements to a software product delivered in the form of a single installable package. Installing a single service pack is easier and more efficient than installing a number of patches individually, especially when updating multiple computers over a network. Service packs are usually numbered and shortly referred to as SP1, SP2, SP3, and so on.

### SUMMARY

A method and a system that involve delivering latest hotfixes with a support package stack are described. In one embodiment, the method includes receiving a selection of a stack of update components, the stack to be applied on a product and receiving correction data for an update component of the stack, the correction data being available on a software provider system. The method also includes detecting the correction data for the update component. Further, the method includes applying the correction data on the update component in the stack.

In one embodiment, the system includes a stack of update components, the stack to be applied on a product and correction data for an update component from the stack of update components, the correction data being available on a software provider system. The system also includes an upgrade tool to detect the correction data for the update component, the correction data is received from the software provider system, and to apply the correction data to the update component in the stack.

### FIGURES

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a sequence diagram of a prior art process for updating a runtime system.

FIG. 2 is an example of a script file, according to an embodiment of the invention, which is executed by an upgrade program.

FIG. 3 is a sequence diagram, according to an embodiment of the invention, for delivering latest hotfixes with an SPS.

FIG. 4 is a data model of en embodiment of the process for updating a system with an SPS and hotfixes.

FIG. 5 is a sequence diagram of an embodiment of the process for delivering latest hotfixes with an SPS according to data model 400.

FIG. 6A is a screenshot of an embodiment for detecting a newer version available for a software component.

FIG. 6B is a screenshot of an embodiment for selecting a newer version available for a software component.

FIG. 7 is a flow diagram of an embodiment for delivering latest hotfixes to a system.

### DETAILED DESCRIPTION

Embodiments of the invention relate to a method and a system for delivering latest hotfixes with a support package stack. A hotfix is a single package that includes one or more files that are used to address a problem in a software product. Generally, hotfixes are made to address a specific customer issue and may not be distributed outside the customer's system. Hotfixes are smaller entities than the software patches, as a hotfix may contain only one or two files. Currently many software companies offer the capability to download and apply hotfixes automatically. The hotfixes, patches, service packs, support packs, and any other upgrade elements may be applied via an upgrade tool. The upgrade tool may be a software program used to update a product with a newer or better version of the same product and thus, to keep a system up-to-date.

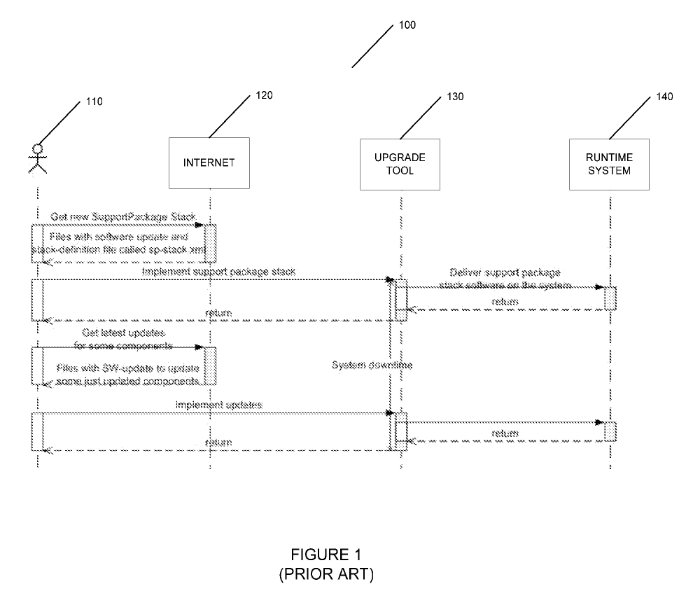

FIG. 1 is a sequence diagram of a prior art process for updating a runtime system. Diagram 100 presents a sequence of steps that are performed to update a runtime system with latest changes. Diagram 100 includes user 110 that is going to perform an upgrade process of a product. User 110 connects to the Internet 120 and more specifically, to a Web site of a company that provides a downloadable version of the latest changes of a given product. For example, SAP AG provides various information, including downloadable updates on all products that it offers, on a Web site called Service Marketplace, located at www.service.sap.com. Using a Web browser, the user 110 may obtain and download the target version of the system components that need to be updated. The target version contains the latest updates of a number of system components for runtime system 140. Runtime system 140 may be any business system including a number of system components. In an embodiment, the runtime system 140 may be an application server consisting of a number of application server instances, each instance including a number of server nodes. Each server node including a number of components responsible for different functionality of the application server node such as, a container responsible for the business logic of any deployed applications, a container responsible for the presentation logic of any deployed applications, a Web service container, and so on. Each of these components and their subcomponents can be updated.

The latest updates for a given product are in the form of a support package stack (SPS). The support package stack may include, besides the files with the latest changes, a stack-definition script file that is to be executed by an upgrade program, such as upgrade tool 130. The script file lists all files for update, as these files may have information such as version number, support package level, patch level, and so on.

After user 110 downloads the SPS of a product, the user may run the upgrade tool 130 to implement the SPS. Upgrade tool 130 locates the downloaded SPS, executes the script file, and delivers the latest files of the product to runtime system 140. The files with the latest changes replace the old files in the runtime system 140.

The support package stacks of a product may be delivered on regular basis by the company that offers the product. During the time between two subsequent SPS deliveries, the company collects issues regarding the particular product. The company fixes the issues in the components that will be delivered with the next support package stack. However, it is possible serious issues to be encountered in an SPS after its delivery to the customer (e.g., security issues.) This will result in fixes of particular files of the SPS. Such files are delivered with support package patches (SPP). The SPPs have the same format as the SPS and are handled in the same way by the upgrade program. The SPP contains all the data initially provided with the SPS and new fixes to some of the files. However, if a customer connects to the Web site of a company and finds for a given product a new SPS and an SPP, it is not recommendable to download and apply the SPP directly without downloading and applying the SPS first. This is because of incompatibility reasons, as it is mostly impossible for the company to test all possible combinations and to guarantee that any combination of such files would work correctly. In addition, any SPP includes a document, such as a release note, describing the issues that the current SPP fixes.

Therefore, in an embodiment, the customers update their systems with the latest SPS and check for any SPPs available for their system components. Depending on the reported issue in the release note of a particular SPP, the customer decides whether to download and apply a given SPP. It is often the case that the customer does not need some fixes because they relate to functionality which the customer is not using. In case the customer decides to apply a fix, the customer (or user 110) downloads the SPP from the Internet Web site 120 and through an upgrade program 130 applies the SPP to runtime system 140. However, this approach has the following drawback: one and the same components are updated twice, first with the SPS and then with the SPP. This leads to longer system update time and thus, to longer business downtime of the system.

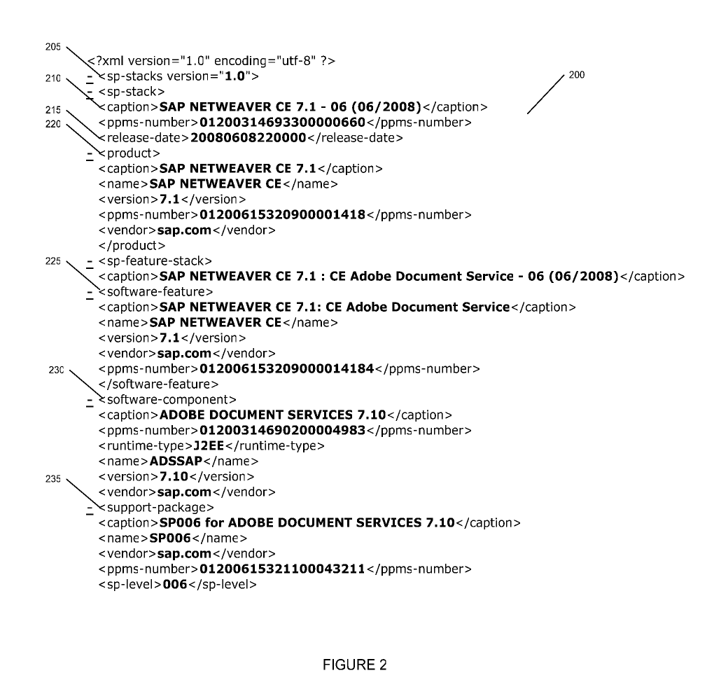

FIG. 2 is an example of a script file that is executed by an upgrade program. In an embodiment, the script file may be written in eXtensible Markup Language (XML). Example 200 shows a part of an XML script file describing a support package stack and the files contained in the SPS. Script 200 may include tags that specify the following information about the SPS: version 205, caption 210; release date 215 of the SPS, product data 220, software features 225, software components 230, support package information for the software component 235, and so on. The script file is executed by the upgrade program and the listed software components are implemented in the runtime system.

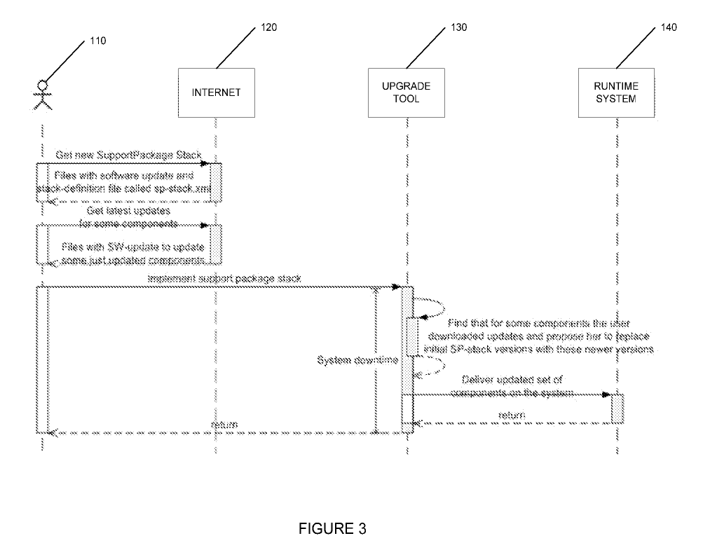

FIG. 3 is a sequence diagram of an embodiment for delivering latest hotfixes with an SPS. Diagram 100 presents a sequence of steps that are performed to update runtime system 140 with latest changes at one time. User 110 connects to the Internet 120, to the Web site of the software provider system that provides updated versions of the product the customer has. The user 110 is offered to download the updated versions of the product and the latest changes to these versions within the same logon to the software provider system. Thus, the user 110 may save time that may result in shorter business downtime when updating the runtime system 140. User 110 downloads the hotfixes for this SPS that he or she wants to apply. Then, the user 110 may run upgrade tool 130 to implement the SPS and the hotfixes to runtime system 140 at one time. In an embodiment, the upgrade tool 130 is an upgrade program that may include a user interface or a command line console for interaction with the user 110. The upgrade tool 130 may allow the user 110 to apply a support package stack, single support packages, third-party components, business packages, and so on.

The user 110 may select the downloaded SPS that wants to apply to runtime system 140. After the selection, the upgrade tool 130 automatically detects that there are newer versions available in the local file system, where the hotfixes were downloaded. The upgrade tool 130 provides to the user 110 possibility to select these newer versions from the hotfixes. In an embodiment, the user 110 may select the newer versions from the hotfixes and the upgrade tool 130 to directly apply the SPS with these versions instead of the original files declared in the script file of the SPS. Thus, runtime system 140 is updated with the latest changes of its components from the SPS and also with the available hotfixes for this SPS at one time. This leads to shorter business downtime of runtime system 140, as no additional time is required for updating the system twice with the same files. The user 110 is able to select and replace some of the files of the SPS with newer versions from the downloaded hotfixes before applying the SPS. This selection is manual, thus the user is able to decide which components to update to the latest versions based on the needs of the user's business scenario.

In an alternative embodiment, the user 110 may decide to apply the SPS directly without selecting any newer versions of the components from the downloaded hotfixes. Later, the user may decide to apply the hotfixes to the runtime system 140 using upgrade tool 130. The files from the hotfixes will replace the files in the runtime system 140 with newer versions. In another embodiment, if the runtime system 140 includes a number of server nodes, user 110 may decide to update all server nodes to the latest available version. The upgrade tool 130 will update all server nodes of runtime system 140 at once with the SPS and the hotfixes selected by the user 110.

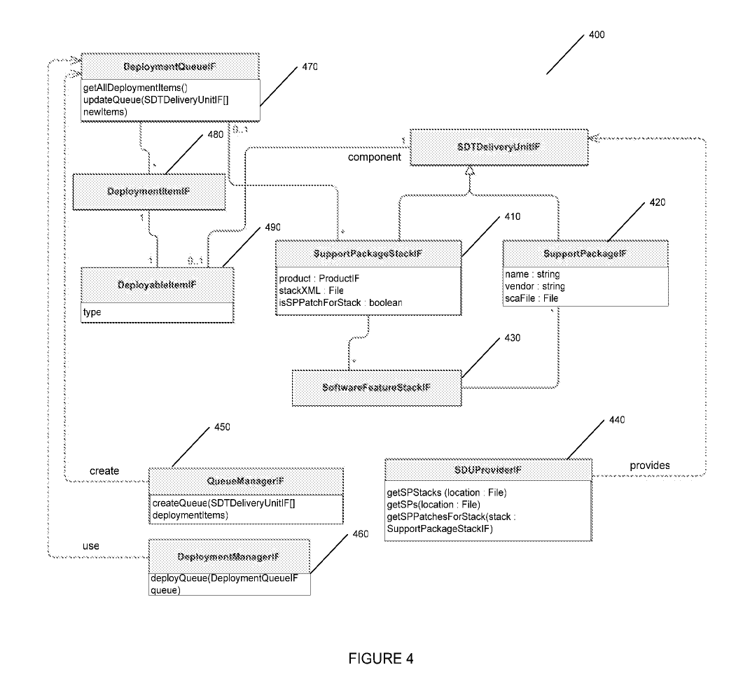

FIG. 4 is a data model of the process for updating a system with an SPS and hotfixes. Generally, a data model is an abstract model that describes how data is represented and accessed. Data models define objects and relationships among the objects. The data model may be presented by a modeling language, such as the Uniform Modeling Language (UML), a subset of the UML or the meta object facility (MOF). In an embodiment, the process of updating a runtime system may be implemented as data model 400. Data model 400 represents a class diagram of programming language classes (or units) that may be used by an upgrade program such as upgrade tool 130. In an embodiment, the programming language classes may be in the Java programming language.

Data model 200 may include: a SupportPackageStackIF 410 interface unit, a SupportPackageIF 420 interface unit, SoftwareFeatureStackIF 430 interface unit, and SDUProviderIF 440 interface unit. The SupportPackageStackIF 410 interface includes the following attributes and methods: product—specifies the product delivered with a support package stack; stackXml—specifies the stack-definition script file that is to be executed by the upgrade program, and isSPPatchForStack ( )—a method that checks if a given support package patch (or hotfix) is applicable for a particular SPS, since the SPPs and hotfixes are made to fix issues in particular SPS. The SupportPackageStackIF 410 interface has a reference to the SoftwareFeatureStackIF 430 interface. The SoftwareFeatureStackIF 430 interface specifies the software features included in the SPS. The SoftwareFeatureStackIF 430 interface has a reference to the SupportPackageIF 420. The SupportPackageIF 420 interface includes the following attributes: name—specifies the name of the support package; vendor—specifies the name of the vendor of the support package; and scaFile—specifies the path to the file with the update components. The SDUProviderIF 440 interface includes the following methods: getSPStacks( )—retrieves all support package stacks that have been downloaded to a given location on the file system; getSPs( )—retrieves all support packages from the SPS; and getSPPatchesForStack( )—retrieves the downloaded hotfixes for a given SPS.

Data model 200 may also include interfaces, such as QueueManagerIF 450, for creating a queue with the retrieved support package stacks, support packages, and hotfixes. The data model 200 may further include interfaces, such as DeploymentManagerIF 460, DeploymentQueueIF 470, and DeploymentItemIF 480, DeployableItemIF 490, for deploying the support packages and hotfixes according to the created queue.

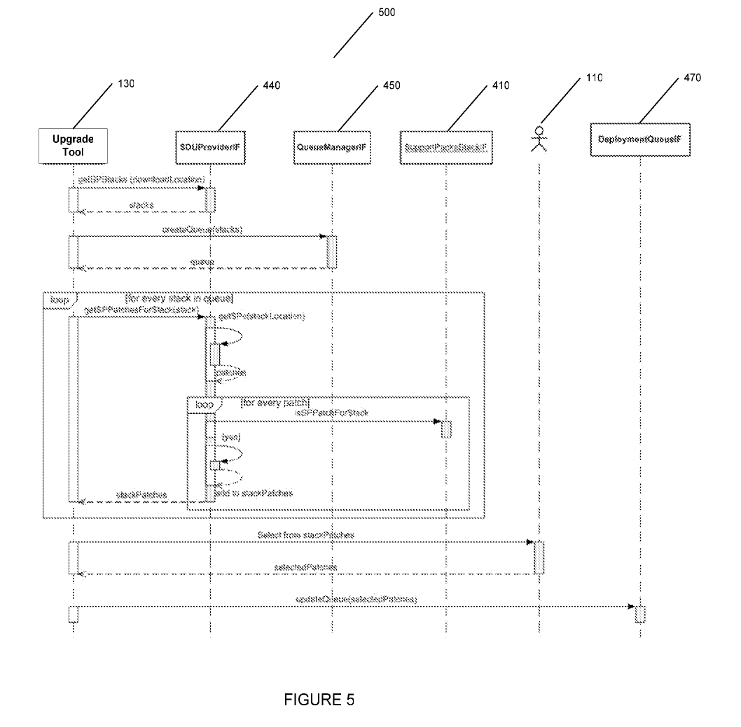

FIG. 5 is a sequence diagram of an embodiment of the process for delivering latest hotfixes with an SPS according to data model 400. Diagram 500 presents the sequence of steps performed in an embodiment to update a system with latest SPS and hotfixes. Upgrade tool 130 may invoke getSPStacks( ) method of the SDUProviderIF 440 interface. The SDUProviderIF 440 interface returns all available downloaded from the Internet 120 support package stacks. Then, the upgrade tool 130 may invoke createQueue( ) method of the QueueManagerIF 450. The QueueManagerIF 450 interface returns a queue containing the support package stacks. For every SPS in the created queue, the upgrade tool 130 may invoke the getSPPatchesForStack( ) method of the SDUProviderIF 440 interface. The SDUProviderIF 440 interface returns the available downloaded hotfixes for a particular SPS. For every hotfix, the SDUProviderIF 440 interface may invoke is SPPatchForStack( ) method of the SupportPackageStackIF 410 interface. The method checks if a given hotfix is made and applicable for the particular SPS. If the returned value is “yes”, then the hotfix is added to a stack of hotfixes. After all hotfixes are checked, the stack of hotfixes is returned to the upgrade tool 130. In an embodiment, if the returned value from the is SPPatchForStack( ) method is “no”, then the hotfix is not added to the stack of hotfixes.

The upgrade tool 130 provides to the user 110 an option to select a hotfix from the stack of hotfixes. In an embodiment, the option may be provided by a Graphical User Interface (GUI). In an alternative embodiment, the option may be provided by a command line console. After the user 110 selects a hotfix, the selected hotfix is returned to the upgrade tool 130. The upgrade tool 130 invokes updateQueue( ) method of the DeploymentQueueIF 470 interface to update the queue and thus, to apply the update components. The deployment interfaces proceed with applying the hotfix to the SPS and replacing the original update components with the corrected components from the hotfix.

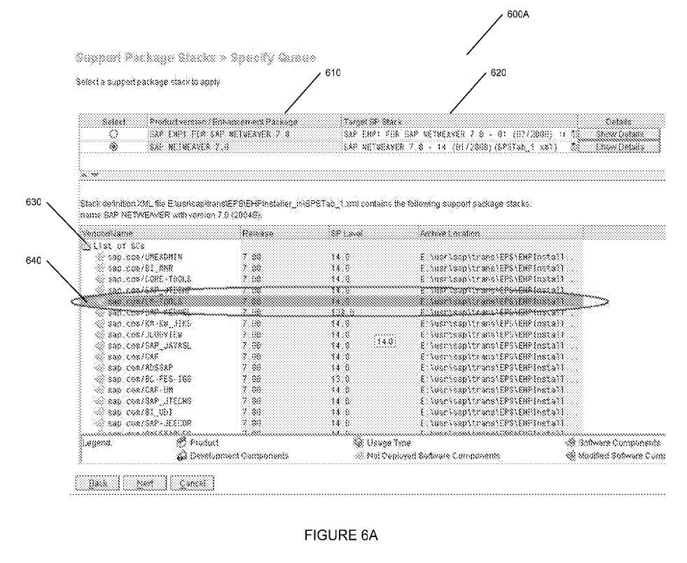

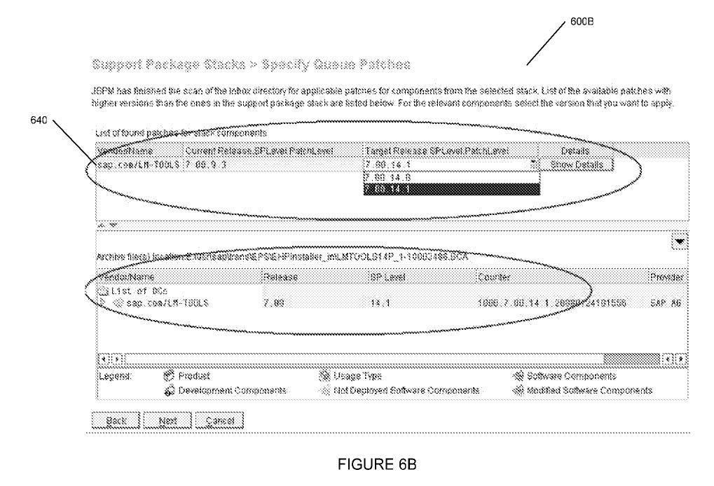

FIG. 6A is a screenshot of an embodiment for detecting a newer version available for a software component. Screenshot 600A is a screenshot of a GUI upgrade program for updating a system, such as runtime system 140, with an SPS. The screenshot 600A shows that the user 110 has selected to update his or her system with an SPS specified with the following information: product SAP NETWEAVER 7.0 from the Product version/Enhancement Package 610 column and SPS 14 from 01/2008 from Target SP Stack 620 column. This is, the user 110 wants to update SAP NETWEAVER 7.0 with SPS release 14 from date: January, 2008. The upgrade program has listed the software components 630 available in the selected SPS. One of the software components 630 is highlighted, this is software component 640. In this way, the upgrade tool 130 indicates that for a given software component, a newer version exists on the file system. It should be appreciated that on a previous step, the upgrade tool 130 has scanned a particular location on the file system, where the user stores any downloaded information, such as SPS, hotfixes, and so on. The highlighted software component 640 may be displayed with version information such as, version (or release) number (e.g., 7.00) and support package level (e.g., 14.0).

FIG. 6B is a screenshot of an embodiment for selecting a newer version available for a software component. Screenshot 600B is a screenshot of a GUI upgrade program for updating a system, such as runtime system 140, with an SPS. In an embodiment, the screenshot 600B is displayed after selection of the Next button from screenshot 600A. Screenshot 600B shows a list of found hotfixes (or patches) for a given software component, such as the highlighted software component 640. The software component 640 is listed with current release number, support package level, and patch level (e.g., 7.00.9.3). The upgrade tool 130 has found newer versions of the software component 640. For example, 7.00.14.0 from the SPS and 7.00.14.1 from the detected hotfix. The user 110 may select the newer version of the software component 640, this is 7.00.14.1. Selecting the newer version from the hotfix triggers replacement of the original files from the SPS with the newer files from the hotfix. In this way, the user 110 will apply to the runtime system 140 the latest available SPS with the latest available hotfixes for this SPS at one time and thus, will avoid longer downtime of the runtime system 140.

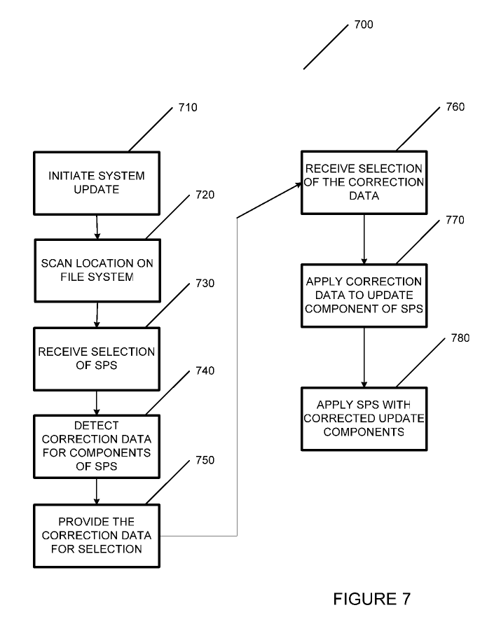

FIG. 7 is a flow diagram of an embodiment for delivering latest hotfixes to a system. Process 700 includes a number of steps that are performed when updating a system with latest versions of the system's components. At block 710, an update procedure is initiated on the system to update a particular product' components to the latest version. The product may be software product such as a program, a software system, an application server, a service, and so on. In an embodiment, the update procedure is initiated through an upgrade program such as upgrade tool 130. At block 720, the upgrade program scans a particular location on the file system to retrieve any stacks of update components with new versions of the product. In an embodiment, the stacks with the update components of the product may be support packages, service packages, patches, etc. The update components may be software components of a system, support components, upgrade components, upgrade packages of files, and so on.

At block 730, a selection of a particular stack of components is received. At block 740, correction data for some of the components in the stack is detected. The correction data may be provided with a downloaded hotfix and may include fixes in some of the update components. At block 750, the correction data of the update components is provided for selection by the user, such as user 110. At block 760, a selection of the correction data of the update components is received. The correction data of the update components is applied to the original update components in the stack, at block 770. At block 780, the stack is applied to the system for performing an update with the update components and the corrected update components with the correction data. Thus, the product (e.g., runtime system 140) is updated with the latest stack of update components and further updated with the latest available correction data for some of the update components in the stack.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program, which may be transferred from a remote computer (e.g., a server) to a requesting computer (e.g., a client) via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. A computerized method comprising:
receiving a selection of a stack of update components, the stack to be applied on a product;
receiving correction data for an update component of the stack, the correction data being available on a software provider system;
detecting the correction data for the update component; and
applying the correction data on the update component in the stack.

2. The method of claim 1, wherein the correction data includes latest available update information.

3. The method of claim 2 further comprising:
applying the stack on the product once, wherein the stack includes the update components and the applied correction data with the latest available update information.

4. The method of claim 1 further comprising:
checking if the correction data for the update component is applicable to the stack of update components; and
if the correction data is applicable, providing the correction data for selection.

5. The method of claim 4 further comprising:
receiving the selection of the correction data for the update component.

6. A computing system comprising:
a stack of update components, the stack to be applied on a product;
correction data for an update component from the stack of update components, the correction data being available on a software provider system; and
an upgrade tool to detect the correction data for the update component, the correction data is received from the software provider system, and to apply the correction data to the update component in the stack.

7. The system of claim 6, wherein the upgrade tool comprises:
a unit to retrieve a number of stacks of update components and any correction data for any of the update components in any of the stacks; and
a unit to create a queue with the number of stacks of update components.

8. The system of claim 6 further comprises:
a unit to check if the correction data of the update component is applicable to the stack of update components; and
if the correction data of the update component is applicable, a stack to which the correction data to be added.

9. The system of claim 8, wherein the stack with the correction data is provided for selection of the correction data.

10. The system of claim 6, wherein the upgrade tool applies the stack of update components and the correction data of the update component once on the product.

11. A computer-readable storage medium having instructions therein that when executed by the machine, cause the machine to:
receive a selection of a stack of update components, the stack to be applied on a product;
receive correction data for an update component of the stack, the correction data being available on a software provider system;
detect the correction data for the update component; and
apply the correction data on the update component in the stack.

12. The computer-readable storage medium of claim 11, wherein the correction data includes latest available update information.

13. The computer-readable storage medium of claim 12 having instructions that when executed further cause the machine to:
apply the stack on the product once, wherein the stack includes the update components and the applied correction data with the latest available update information.

14. The computer-readable storage medium of claim 11 having instructions that when executed further cause the machine to:
check if the correction data for the update component is applicable to the stack of update components; and
if the correction data is applicable, provide the correction data for selection.

15. The computer-readable storage medium of claim 14 having instructions that when executed further cause the machine to:
receive the selection of the correction data for the update component.
